(19) United States
(12) Patent Application Publication
(10) Pub. No.: US 2006/0197842 A1
(43) Pub. Date: Sep. 7, 2006

(54) Image capturing apparatus

(75) Inventors: Kazuki Akaho, Osaka (JP); Shinichi Maehama, Osaka (JP)

Correspondence Address: BRINKS HOFER GILSON & LIONE, P.O. BOX 10395, CHICAGO, IL, 60610, US

(73) Assignee: KONICA MINOLTA PHOTO IMAGING, INC.

(21) Appl. No.: 11/294,589

(22) Filed: Dec. 5, 2005

(30) Foreign Application Priority Data
Mar. 7, 2005 (JP) JP2005-062260

(51) Int. Cl. H04N 5/225

(52) U.S. Cl. 348/207.99; 348/231.9

(57) ABSTRACT

An image capturing apparatus which may for example be a digital camera is capable of reading respective pieces of information stored in IC tags. These pieces of information stored in the IC tags are each given additional information in advance that indicates the degree of priority of the stored information. Thus even when mutually incompatible shooting conditions are requested in the respective pieces of information stored in these IC tags, stored information given high priority can be selected based on the degree of priority indicated by the foregoing additional information. As a result, the image capturing apparatus is allowed to operate in a suitable manner even when mutually incompatible pieces of information are received from a plurality of IC tags.

This application is based on application No. 2005-62260 filed in Japan, the contents of which are hereby incorporated by reference.

### BACKGROUND OF THE INVENTION

1. Field of the Invention

The present invention relates to an image capturing apparatus capable of reading several pieces of information stored in IC tags.

2. Description of the Background Art

A device so-called IC tag has been developed and received much attention. This IC tag is formed by an IC (integrated circuit) chip with each side for example of 1 mm or less, storing information readable by radio communication. Various uses of this IC tag have been suggested as introduced for example in Japanese Patent Application Laid-Open No. 2001-145173.

When the information sent from the IC tag is received by a digital camera (image capturing apparatus) for use therein and if a plurality of IC tags are present in the vicinity of the image capturing apparatus, the image capturing apparatus receives information from all the receivable IC tags. If the received pieces of information contain mutually incompatible contents, it is hard for the digital camera to precisely determine which piece of information should be selected.

### SUMMARY OF THE INVENTION

The present invention is intended for an image capturing apparatus.

According to the present invention, the image capturing apparatus comprises: a reader capable of reading respective pieces of stored information in a plurality of IC tags; and a selector for selecting stored information given high priority from the respective pieces of stored information based on additional information given to each of the respective pieces of stored information. The additional information indicates the degree of priority of the stored information.

Thus even when mutually incompatible pieces of information are received from a plurality of IC tags, the image capturing apparatus is allowed to operate in a suitable manner.

Preferably, the image capturing apparatus further comprises: a setting part for setting shooting condition related to the image capturing apparatus based on the stored information selected by the selector.

Thus shooting condition reflecting the information sent from an IC tag can be suitably set.

It is therefore an object of the present invention to provide an image capturing apparatus capable of operating in a suitable manner even when mutually incompatible pieces of information are received from a plurality of IC tags.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an image capturing apparatus 1 according to a preferred embodiment of the present invention;

FIG. 2 is a rear view of the image capturing apparatus 1;

FIG. 3 is a functional block diagram of the image capturing apparatus 1;

FIG. 4 shows an example of the case in which two IC tags are present in the vicinity of the image capturing apparatus 1; and

FIG. 5 is a flow chart showing the basic operation of the image capturing apparatus 1.

### DESCRIPTION OF THE PREFERRED EMBODIMENTS

<Configuration of Main Part of Image Capturing Apparatus>

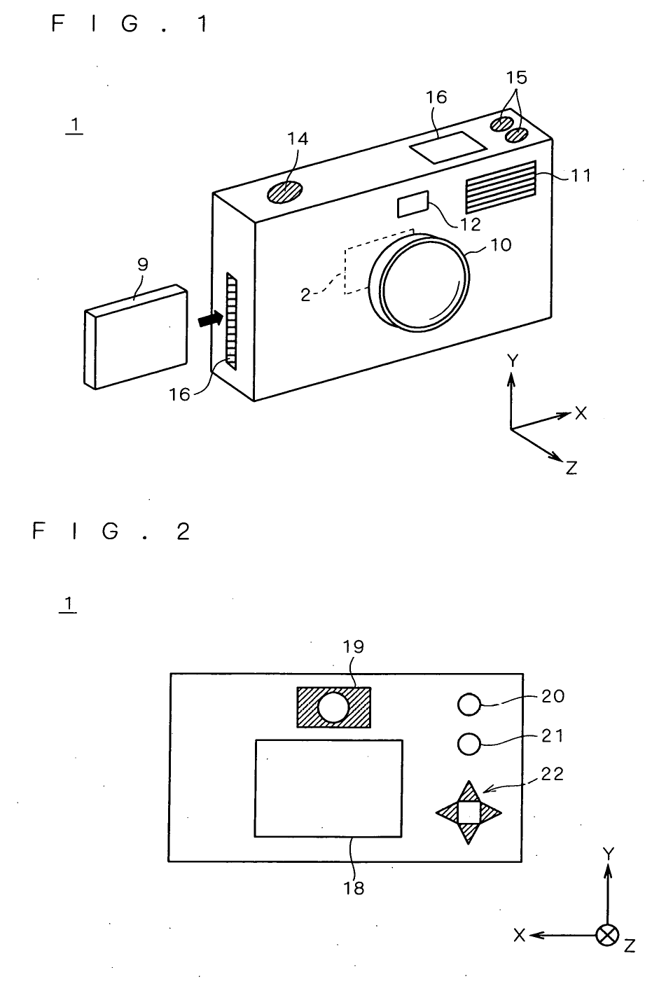

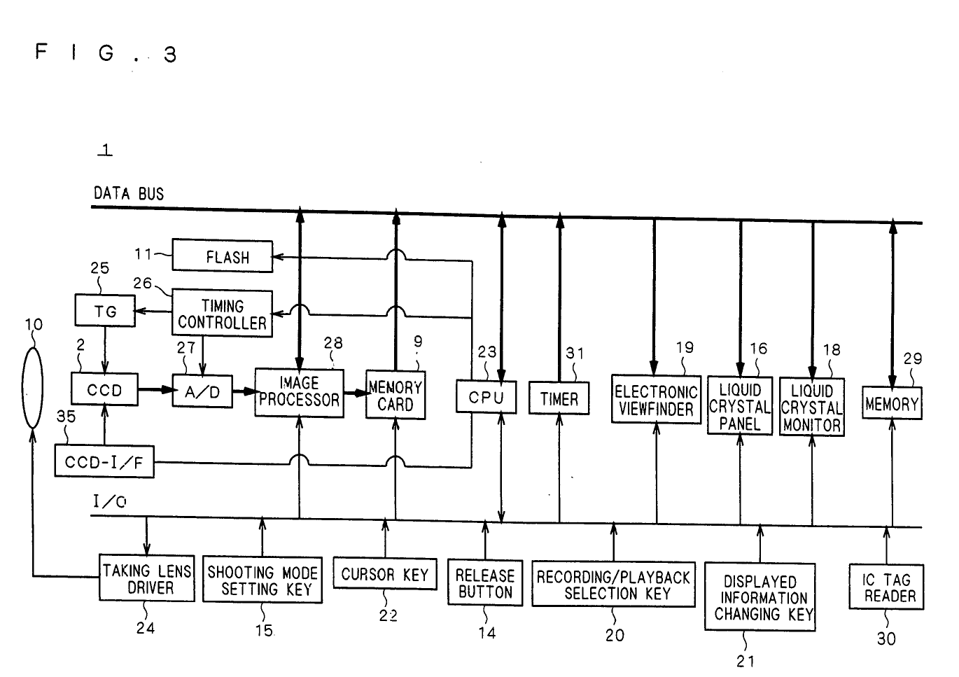

FIG. 1 is a perspective view of an image capturing apparatus 1 according to a preferred embodiment of the present invention. FIG. 2 is a rear view of the image capturing apparatus 1. In FIGS. 1 and 2, three axes, namely X, Y and Z axes orthogonal to each other are shown to clarify directional relationship.

The image capturing apparatus 1, which may for example be a digital camera, has a taking lens 10, a flash 11 and a distance measuring window 12 on the front side. A CCD (charge coupled device) 2 as an image capturing device is arranged inwardly of the taking lens 10 that performs photoelectric conversion upon an image of a subject entering the CCD 2 through the taking lens 10 to generate an image signal.

The taking lens 10 has a lens system that can be driven in the direction of an optical axis. When this lens system is driven in the direction of an optical axis, an image of a subject can be formed on the CCD 2 under in-focus condition.

A release button 14, a shooting mode setting key 15 and a liquid crystal panel 16 are arranged on the top surface of the image capturing apparatus 1. The release button 14 is a two-stage push-in switch capable of detecting half-pressed state (S1 ON) and fully-pressed state (S2 ON). The half press of the release button 14 triggers autofocus (AF), whereas the full press of the release button 14 triggers actual shooting operation for obtaining an image to be recorded.

While visually recognizing the information about settings displayed on the liquid crystal panel 16, a user is capable of setting exposure condition such as aperture priority or shutter speed priority, switching to macrophotography mode, making zoom setting and the like by using the shooting mode setting key 15.

A slot 16 is provided on the side surface of the image capturing apparatus 1 through which a memory card 9 for storing image data obtained in actual shooting operation triggered by the user's press of the release button 14 is attached to or detached from the image capturing apparatus 1.

A liquid crystal monitor 18, an electronic viewfinder 19, a recording/playback selection key 20, a displayed information changing key 21 and a cursor key 22 are provided on the rear surface of the image capturing apparatus 1. The liquid crystal monitor 18 and the electronic viewfinder 19 produce live view display of a subject in the form of moving images before actual shooting operation, and produce playback of captured images. The displayed information changing key 21 changes the mode of displaying information.

The recording/playback selection key 20 serves to realize switching between recording state (recording mode) and playback state (playback mode). More specifically, a user uses the recording/playback selection key 20 to select recording or playback state as shown in Table 1 below:

TABLE 1

| | Setting | Detail |
|---|---|---|
| Recording/Playback | OFF | Recording State |
| Selection Key | ON | Playback State |

The cursor key 22 is responsible for adjustment of zooming during image shooting, frame advance and the like in image playback.

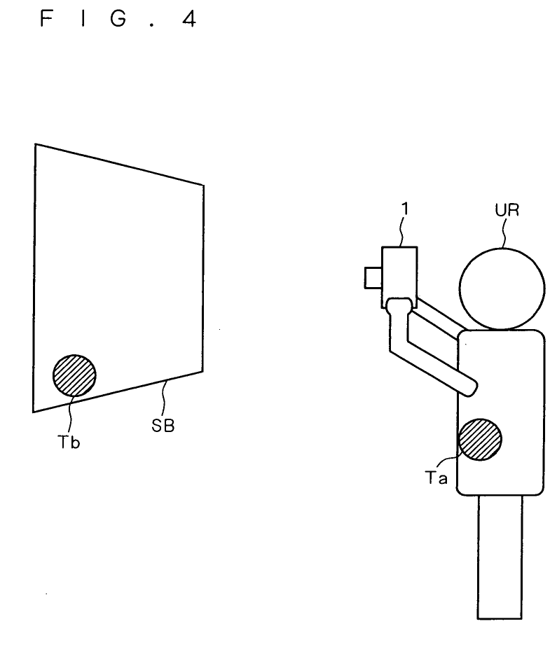

FIG. 3 is a functional block diagram of the image capturing apparatus 1. In FIG. 3, bold lines with arrow heads represent the flow of image data, and thin lines with arrow heads represent the flow of control data.

First, a user uses the recording/playback selection key 20 and the liquid crystal monitor 18 to select the recording state or playback state as shown in Table 1. In the following, the recording and playback states will be separately discussed.

(1) Recording State

When the recording/playback selection key 20 is at OFF, namely when the image capturing apparatus 1 is set at the recording state, the user uses the shooting mode setting key 15 and the liquid crystal panel 16 to set exposure condition such as shutter speed priority and realize switching to white balancing mode (image processing mode), for example.

The press of the release button 14 causes a CPU 23 to read the then shooting conditions and settings related to image processing mode to perform image shooting. For setting some of the shooting conditions, an IC tag reader 30 detects a receivable IC tag present in the vicinity of the image capturing apparatus 1, and reads the information of this IC tag stored in a memory 29 (as will be discussed below). For setting other shooting conditions which cannot be obtained from an IC tag, the user uses the shooting mode setting key 15 to read the information thereby set. The IC tag reader 30 is also operative to function as an IC tag writer capable of rewriting information stored in an IC tag.

If flash photography is selected, the CPU 23 controls the flash 11 based on light emission timing and light emission period. In this case, a timer 31 determines the timing for starting and stopping light emission.

In the foregoing shooting operation, a taking lens driver 24 drives the taking lens 10 to be in focus with a subject. Then the CCD 2 is caused to perform integral action, namely charge storage to read image data from the CCD 2. The drive of the CCD 2 is controlled through a CCD-I/F 35 and timing pulses are generated by TG (timing generator) 25. A timing controller 26 generates clocks for use in the TG 25 and in an A/D converter 27.

The image data obtained by the CCD 2 is converted to digital data at the A/D converter 27. The A/D converter 27 converts an analog signal sent from the CCD 2 to a digital signal based on the timing pulses generated at the timing controller 26.

An image processor 28 is responsible for image processing upon the image data sent from the A/D converter 27 such as gain processing, white balance correction and color shading correction using a shading table, for example. The processed image data is then stored in the memory card 9 operative to function as a recording medium.

(2) Playback State

When the recording/playback selection key 20 is at ON, namely when the image capturing apparatus 1 is set at the playback state, the CPU 23 reads image data from the memory card 9, and sends the read image data to the memory 29 for temporary storage. Then the CPU 23 sends the image data stored in the memory 29 to the image processor 28. The image processor 28 is responsible for conversion of the image data sent from the memory 29 to a format capable of being displayed on the liquid crystal monitor 18 and the electronic viewfinder 19. The converted image data is sent for example to the liquid crystal monitor 18 for use in the display thereon.

<Shooting Condition Setting Based on Information Stored in IC Tag>

As discussed, in the image capturing apparatus 1, the IC tag reader 30 detects an IC tag spaced from the image capturing apparatus 1 and reads the setting requested by this IC tag, thereby setting shooting condition. When the IC tag reader 30 detects a plurality of IC tags, mutually incompatible settings may be requested by these IC tags. In the following, the manner in which the image capturing apparatus 1 operates in such a case will be discussed in detail.

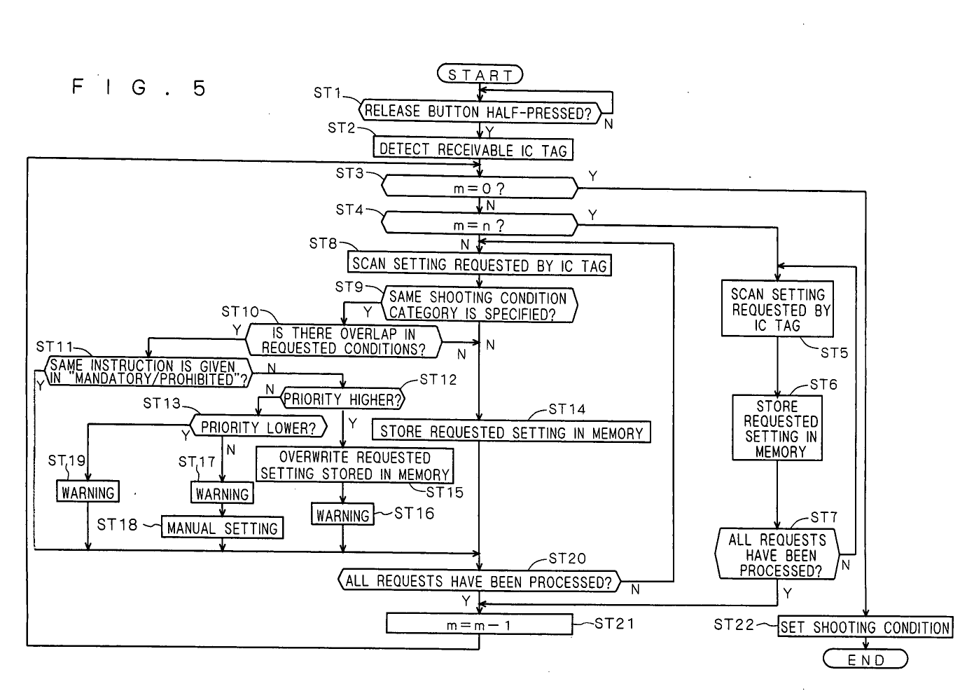

FIG. 4 shows an example of the case in which two IC tags Ta and Tb are present in the vicinity of the image capturing apparatus 1.

The IC tag Ta is kept for example in the pocket in the clothes of a user UR who uses the image capturing apparatus 1 to capture an image of a subject SB. The IC tag Tb is built into the subject SB. The image capturing apparatus 1 is capable of detecting both the IC tags Ta and Tb to read the information stored in the IC tags Ta and Tb using the IC tag reader 30.

Next, it will be discussed how the image capturing apparatus 1 operates in the foregoing situation referring to three examples (cases).

### (1) FIRST EXAMPLE

In the first example, the IC tags Ta and Tb store information shown in Table 2 below:

TABLE 2

| | Shooting Condition | Requested | Mandatory/ | |
|---|---|---|---|---|
| | Category | Condition | Prohibited | Priority |
| IC Tag Ta | Shooting Mode | Aperture | 1 | 5 |
| | | Priority | | |
| IC Tag Tb | Flash Photography | All | 0 | 10 |

As shown in Table 2, the IC tags Ta and Tb each store information divided into four groups including “Shooting Condition Category”, “Requested Condition”, “Mandatory/Prohibited” and “Priority”.

In the group “Shooting Condition Category” (major division), categories of shooting condition such as shooting mode or flash photography are stored. In the group “Requested Condition”, detailed conditions required in the shooting condition specified in “Shooting Condition Category” (shooting control information) are stored. In Table 2, the shooting condition category and requested condition are expressed in words. However, these pieces of information are actually stored in the form of codes. For example, shooting mode is expressed as 0001 and aperture priority is expressed as 001.

In the group “Mandatory/Prohibited”, the mandatory setting of shooting condition is expressed as “1”, whereas the prohibition of setting of shooting condition is expressed as “0”. The “Priority” (degree of priority) is additional information intended to decide which requested condition should be given higher priority if a plurality of mutually incompatible conditions are requested. The priority among the requested conditions under the specified shooting condition category is expressed in ten stages from “1” (minimum value) to “10” (maximum value). The higher value shows higher priority. As the priority is expressed by numerical values (absolute values), suitable piece of information can be easily selected from mutually incompatible pieces of information as discussed below by making relative comparison between these numerical values.

Accordingly, it is seen from the information listed in Table 2 that the IC tag Ta requests the image capturing apparatus 1 to employ aperture priority mode under the category of shooting mode, and that the IC tag Tb requests the image capturing apparatus 1 to prohibit all light emission operations (such as red-eye reduction and normal light emission) under flash photography, namely, prohibits flash photography itself.

When the IC tags Ta and Tb specify different shooting condition categories, shooting conditions requested by the IC tags Ta and Tb can be concurrently satisfied. Then the image capturing apparatus 1 makes settings that satisfy both the shooting conditions requested by the IC tags Ta and Tb without making reference to the group “Priority” (Table 2). That is, in the image capturing apparatus 1, shooting conditions are set such that aperture priority mode is employed while light emission by the use of the flash 11 is prohibited. Shooting conditions that are not requested by the IC tags Ta and Tb are set for example by the operation of the shooting mode setting key 15 by the user.

When the image capturing apparatus 1 is capable of determining that the user UR keeps the IC tag Ta, the user UR may be allowed to freely change the shooting condition that is set based on the information stored in the IC tag Ta by using for example the shooting mode setting key 15. In this case, the IC tag Ta may store information specific to the image capturing apparatus 1 (such as identification information), from which the IC tag Ta is supposed to be an IC tag kept by the user who possesses the image capturing apparatus 1.

### (2) SECOND EXAMPLE

In the second example, the IC tags Ta and Tb store information shown in Table 3 below:

TABLE 3

| | Shooting Condition | Requested | Mandatory/ | |
|---|---|---|---|---|
| | Category | Condition | Prohibited | Priority |
| IC Tag Ta | Flash Photography | Normal Light | 1 | 5 |
| | | Emission | | |
| IC Tag Tb | Flash Photography | All | 0 | 10 |

It is seen from the information listed in Table 3 that the IC tag Ta forces the image capturing apparatus 1 to perform flash photography with normal light emission, and that the IC tag Tb requests the image capturing apparatus 1 to prohibit all light emission operations in flash photography.

As seen from Table 3, the IC tags Ta and Tb specify the same shooting condition category while requesting overlapping shooting conditions and giving different instructions in the group “Mandatory/Prohibited”. That is, the IC tags Ta and Tb request mutually incompatible settings of shooting conditions. Then the image capturing apparatus 1 makes reference to the priorities stored in the IC tags Ta and Tb to make settings based on the requested condition given the higher priority. More specifically, the IC tag Tb is given the priority “10” higher than the priority “5” given to the IC tag Ta. Thus the image capturing apparatus 1 sets shooting condition such that an image should be captured with no flash.

As discussed, when the respective pieces of information stored in the IC tags Ta and Tb read by the IC tag reader 30 contain mutually incompatible contents, the requested shooting condition given the higher priority is selected based on the priority given to each stored information. Thus even when a plurality of IC tags request mutually incompatible shooting conditions, such incompatibility can be readily resolved.

When it can be determined that the IC tag Tb is arranged on the side of the subject SB, it is preferable to prohibit the user from arbitrarily rewriting the request to prohibit flash photography stored in the IC tag Tb.

### (3) THIRD EXAMPLE

In the third example, the IC tags Ta and Tb store information shown in Table 4 below:

TABLE 4

| | Shooting Condition | Requested | Mandatory/ | |
|---|---|---|---|---|
| | Category | Condition | Prohibited | Priority |
| IC Tag Ta | Flash Photography | Normal Light | 1 | 10 |
| | | Emission | | |
| IC Tag Tb | Flash Photography | All | 0 | 10 |

It is seen from the information listed in Table 4 that the IC tag Ta forces the image capturing apparatus 1 to perform flash photography with normal light emission, and that the IC tag Tb requests the image capturing apparatus 1 to prohibit all light emission operations in flash photography.

As seen from Table 4, the IC tags Ta and Tb specify the same shooting condition category while requesting overlapping shooting conditions and giving different instructions in the group “Mandatory/Prohibited”. That is, the IC tags Ta and Tb request mutually incompatible settings of shooting conditions. Further, the IC tags Ta and Tb are given the same priority, and hence the incompatibility between the requests from the IC tags Ta and Tb cannot be resolved by the priorities.

In this case, the image capturing apparatus 1 informs the user UR that the incompatibility cannot be resolved for example by issuing a warning beep, thereby urging the user UR to make manual setting of shooting conditions. Thus even when the incompatibility cannot be resolved by the priorities, shooting conditions can be set by the user.

As discussed, when a plurality of IC tags request mutually incompatible settings of shooting conditions while being given the same priority, the user is alerted to make manual setting. This allows a high degree of reliability in setting shooting condition.

In the third example, a warning beep may be issued and the prohibition instruction in the group “Mandatory/Prohibited” stored in the IC tag Tb may be given higher priority, thereby automatically prohibiting flash photography.

Sill alternatively, when it can be determined that the IC tag Tb is arranged on the side of the subject SB, a warning beep may be issued and the condition requested by the IC tag Tb may be given higher priority.

Next, the basic operation of the image capturing apparatus 1 with the foregoing configuration will be discussed.

<Operation of Image Capturing Apparatus 1>

FIG. 5 is a flow chart showing the basic operation of the image capturing apparatus 1 controlled by the CPU 2.

In step ST1, it is determined whether the release button 14 has been half-pressed (S1 ON) by a user. If the release button 14 has been half-pressed, the flow goes to step ST2. If not, step ST1 is repeated.

In step ST2, the IC tag reader 30 detects a receivable IC tag present in the vicinity of the image capturing apparatus 1. At this time, the number of detected IC tags is counted and stored in parameter regions “n” and “m” in the memory 29.

In step ST3, it is determined whether the parameter m equals 0. If m=0 is satisfied as a result of the fact that no IC tag has been detected in step ST2, for example, the flow goes to step ST22. If m>0, the flow goes to step ST4.

In step ST4, it is determined whether the parameters m and n are equal. If m=n, the flow goes to step ST5. If m<n, the flow goes to step ST8.

In step ST5, the IC tag reader 30 scans and reads the shooting condition requested by a first one among n pieces of IC tags detected in step ST2.

In step ST6, the requested shooting condition read in step ST5 is stored in the memory 29. Unlike the shooting conditions requested by a second and subsequent IC tags discussed later, the shooting condition requested by the first IC tag is unconditionally stored in the memory 29.

In step ST7, it is determined whether all the shooting conditions requested by the IC tag have been scanned and stored. If all the shooting conditions have been stored, the flow goes to step ST21. If not, the flow returns to step ST5.

In step ST8, the IC tag reader 30 scans the shooting condition requested by an IC tag selected from the n pieces of IC tags detected in step ST2 and different from the IC tag scanned in step ST5.

In step ST9, it is determined whether the request scanned in step ST8 specifies the same shooting condition category as that specified by any one of the requests stored in the memory 29. If there is a match in shooting condition category, the flow goes to step ST10. If not, the flow goes to step ST14.

In step STI0, it is determined whether the request scanned in step ST8 specifies a condition that overlaps the condition specified by the request stored in the memory 29 that has been judged as specifying the same shooting condition category in step ST9. The overlap of the conditions means partial match of the conditions represented for example by the relationship between “normal light emission” and “all” as shown in Table 3, as well as complete match of the conditions. If there is overlap of conditions, the flow goes to step STI1. If not, the flow goes to step ST14.

In step ST11, it is determined whether the request scanned in step ST8 selects mandatory or prohibited setting of shooting condition in the same manner that the request stored in the memory 29 that has been judged as specifying the same shooting condition category and overlapping condition in steps ST9 and ST10 selects mandatory or prohibited setting of shooting condition. If there is match in mandatory/prohibited setting, the flow goes to step ST20. If there is no match in mandatory/prohibited setting, it is judged that incompatible shooting conditions are requested. In this case, the flow goes to step ST12 to make reference to the priorities.

In step ST12, it is determined whether the request scanned in step ST8 is given higher priority than that given to the incompatible request stored in the memory 29. If the request scanned in the step ST8 is given higher priority, the flow goes to step ST15. If this request is not given higher priority, the flow goes to step ST13.

In step ST13, it is determined whether the request scanned in step ST8 is given lower priority than that given to the incompatible request stored in the memory 29. If the request scanned in step ST8 is given lower priority, the flow goes to step ST19. If this request is not given lower priority, the flow goes to step ST17.

In step ST14, the request scanned in step ST8 is stored in the memory 29. The operation in step ST14 is realized for example in the case where the requests from the IC tags Ta and Tb can be concurrently satisfied as in the foregoing first example.

In step ST15, the request stored in the memory 29 is overwritten with the request scanned in step ST8. The operation in step ST15 is realized for example in the case where the requests from the IC tags Ta and Tb are mutually incompatible as in the foregoing second example.

In step ST16, a warning is issued to inform that the request stored in the memory 29 has been overwritten. As an example, a warning message may be displayed on the liquid crystal monitor 18 or a warning beep may be generated.

In step ST17, a warning is issued to inform that the incompatibility between the request scanned in step ST8 and the request stored in the memory 29 cannot be resolved. The operation in step ST17 is realized for example in the case where the requests from the IC tags Ta and Tb are mutually incompatible while being given the same priority as in the foregoing third example.

In step ST18, the user makes manual setting of shooting condition. This allows reliable setting of shooting condition even when the incompatibility cannot be resolved by the priorities.

In step ST19, a warning is issued to inform that the request scanned in step ST8 is rejected.

Like in step ST7, it is determined in step ST20 whether all the shooting conditions requested by the IC tag have been scanned and stored. If all the shooting conditions have been stored, the flow goes to step ST21. If not, the flow returns to step ST8.

In step ST21, the parameter m is substituted by a parameter (m6−1).

In step ST22, shooting condition is set based on the request of an IC tag stored in the memory 29. That is, a shooting condition is employed that is selected based on the priorities given to IC tags. Then the full press of the release button 14 by the user triggers shooting operation under the shooting condition thereby set.

According to the foregoing operations of the image capturing apparatus 1, the information stored in an IC tag related to shooting condition is previously given priority. Thus even when mutually incompatible pieces of information are received from a plurality of IC tags, the image capturing apparatus 1 is allowed to operate in a suitable manner.

The change of priority using for example the IC tag write function of the IC tag reader 30 may be allowed only for an IC tag held by a user of the image capturing apparatus 1, while preventing other IC tags from being changed in priority. This avoids disordered change of priorities by a user to thereby suitably make use of IC tags with regard to priorities.

A user of the image capturing apparatus 1 may be prevented from changing the priority of an IC tag given priority close to a maximum. More specifically, in the image capturing apparatus 1, the rewrite of priority using for example the IC tag write function of the IC tag reader 30 may be prohibited with regard to an IC tag assigned the priority close to the upper limit (in the range of 8 to 10, for example) of the priorities expressed by numerical values from 1 to 10 as discussed. This avoids an undesirable situation where an IC tag even given high priority is easily subjected to the change of priority to substantially lose the significance of priority. As the disordered change of priorities is limited, suitable use of IC tags with regard to priorities is realized.

The priority given to an IC tag may depend on the installation location of the IC tag. As an example, if an IC tag arranged in a public area is given high priority, improper image shooting in the public area is prevented to allow suitable management of the priority responsive to the location.

<Modifications>

In the preferred embodiment described above, the information stored in an IC tag is not necessarily required to be scanned after the half press of the release button 14 as indicated in the flow chart of FIG. 5. Alternatively, the information in an IC tag may be scanned immediately after the turn-on of an image capturing apparatus, or during setting of shooting condition by the shooting mode setting key 15.

The image capturing apparatus of the present invention is not limited to the digital camera as discussed, but is also applicable to a video camera, a camera-equipped cell phone having image shooting function or the like.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus, comprising:
(a) a reader capable of reading respective pieces of stored information in a plurality of IC tags; and
(b) a selector for selecting stored information given high priority from said respective pieces of stored information based on additional information given to each of said respective pieces of stored information, said additional information indicating a degree of priority of said stored information.

2. The image capturing apparatus according to claim 1, further comprising:
(c) a setting part for setting shooting condition related to said image capturing apparatus based on said stored information selected by said selector.

3. The image capturing apparatus according to claim 1,
wherein said degree of priority is as a numerical value.

4. The image capturing apparatus according to claim 1,
wherein a change of said degree of priority is allowed only for an IC tag held by a user of said image capturing apparatus, said IC tag held by said user being selected from said plurality of IC tags.

5. The image capturing apparatus according to claim 1,
wherein said degree of priority has an upper limit, and
wherein a user of said image capturing apparatus is prevented from changing said degree of priority of an IC tag given said degree of priority close to said upper limit.

6. The image capturing apparatus according to claim 1,
wherein said degree of priority is determined depending on an installation location of an IC tag.
